(19) United States
(12) Patent Application Publication
(10) Pub. No.: US 2026/0249944 A1
(43) Pub. Date: Aug. 27, 2026

(54) VEHICLE

(71) Applicant: Rodney Ian Rawlinson, Moreleta Park (ZA)

(72) Inventor: Rodney Ian Rawlinson, Moreleta Park (ZA)

(21) Appl. No.: 18/872,787

(22) PCT Filed: Jun. 6, 2023
(86) PCT No.: PCT/IB2023/055800

§ 371 Date: Dec. 6, 2024

(30) Foreign Application Priority Data
Jun. 6, 2022 (ZA) 2022/06237

(51) Int. Cl. B62K 13/04; B62J 1/08; B62J 37/00; B62J 43/16; B62K 5/01; B62K 5/027; B62K 5/05; B62K 5/06; B62K 5/10; B62K 13/08; B62K 21/16

(52) U.S. Cl. CPC B62K 13/04; B62J 1/08; B62J 37/00; B62J 43/16; B62K 5/01; B62K 5/027; B62K 5/05; B62K 5/06; B62K 5/10; B62K 13/08; B62K 21/16

(57) ABSTRACT

This invention relates to a type of vehicle. More specifically, the invention relates to a personal mobility three or four-wheeled vehicle incorporating a rider platform pivot-mounted to side frames for enabling the rider, when standing or sitting and without the need to place their feet onto the road surface, to physically balance and control the vehicle at all speeds and to keep it upright when stopping or when reversing. By straddling the rider platform, and through manipulation of the vehicle's handle bar, a rider is capable of tilting the vehicle wheels to the left or right of vertical as required. The vehicle includes a platform for supporting a rider, a pair of primary assemblies pivotally connected to a first connecting end of the platform; at least one secondary wheel assembly pivotally connected to a second connecting end of the platform, at least one transverse connector pivotally connected to the primary wheel assemblies so as to constrain the primary wheel assemblies to a synchronous lateral tilting movement relative to the platform, and at least one longitudinal connector rigidly connecting the secondary wheel assembly in a manner to constrain it to a lateral tilting movement synchronous with the primary wheel assemblies. The first and second connecting ends of the platform delimit a longitudinal platform span, longitudinally outside of which the wheel assemblies lie such that at least an upper support surface of lateral sides of the platform are clear from obstruction to enable lateral step-on entry onto the platform by the rider from either lateral side thereof.

### CROSS-REFERENCE TO RELATED APPLICATION(S) INFORMATION

This is a U.S. 371 National Stage Entry application of International PCT patent application No. PCT/IB2023/055800, filed Jun. 6, 2023, published as WO2023/238020A1, and which claims benefit of/priority to South African patent application No. 2022/06237, filed Jun. 6, 2022, all of which are incorporated herein by reference in entirety.

### BACKGROUND

This invention relates to a type of vehicle. More specifically, the invention relates to a personal mobility three or four-wheeled stand-on or sit-on vehicle incorporating a rider platform pivot-mounted to side frames for enabling the rider, when standing or sitting and without the need to place their feet onto the road surface, to balance and control the vehicle at all forward speeds, when stopping or when reversing. By straddling the rider platform, and through manipulation of the vehicle's handle bar, a rider is capable of tilting or leaning the vehicle wheels to the left or right of vertical as required, and to balance and control the vehicle with a normal motorcycle leaning motion.

Tilting or leaning vehicles are very well known, typically available as three-or four-wheeled versions. Primarily, the aim of these vehicles is to provide the feel, excitement and cornering experience of a motorcycle, with the safety, control and stability of an automobile.

Rawlinson (the inventor of the present invention described herein) has previously filed patent applications for earlier versions of his tilting vehicles. In South African patent no. 2006/03927, Rawlinson teaches of a four-wheeled tilt vehicle comprising essentially of two motorcycle side frames, each having front and aft wheels, pivotally connected side-to-side to a central seat frame on which a seated rider is supportable. While this vehicle provides the stability and experience tilting vehicles are expected to provide, the vehicle has a few shortcomings.

Firstly, the riders must have sufficient agility to position one leg between the side frames and the central seat frame while balancing the vehicle, and then straddle mount the central seat frame to orientate themselves in a seated position on the central seat frame. Secondly, when coming to a stop, it is impossible for the rider to put his feet to the ground making it very difficult to balance the stationary vehicle. Thirdly, with parts of the side frames located between struts pivotally connecting the side frames to the central seat frame, the rider's foot is prone to becoming trapped between the side frames and the central seat frame during a leaning manoeuvre, which can lead to injury or an accident.

In South African patent no. 2012/06061, Rawlinson teaches of a four-wheeled tilt vehicle aimed specifically at addressing the shortcomings of his previous version. In essence, the side frames of the previous version of the vehicle are replaced by front and rear pairs of wheeled sub-frames, each being pivotally connected to a chassis, with the front sub-frames pivotally connected to a central seat frame by a front transverse member and the rear sub-frames pivotally connected to the central seat frame by a rear transverse member. This setup enables the chassis to be designed with a narrowing, permitting the rider to more easily balance the vehicle by setting at least one foot on the ground during mounting and bringing the vehicle to a stationary condition, addressing two of the three of the previous vehicles'shortcoming.

Although the footing of the rider in this version better protects the rider's feet from becoming trapped during a leaning manoeuvre, the feet of a passenger remain vulnerable. Also, this setup does not lend itself well to riding in a standing position.

It is an object of the present invention to provide a simplified stand-on only or combination sit-on or stand-on three or four-wheeled vehicle that addresses the abovementioned shortcomings.

Reference to the term “post” in this specification will be understood to not only include its normal dictionary definition, i.e. a long, sturdy piece of timber or metal set upright in the ground and used as a support or marker, but also a member of any shape having a dimension longer than a height dimension “H” of a platform of the vehicle, as indicated in FIG. 4.

Reference to the term “substantially L-shaped support frame” in this specification will be understood to include a support frame having an angle, as measured between a support post and a support beam making up the support frame, of 90 degrees plus or minus a variance of up to 15 degrees therefrom.

### SUMMARY

According to the inventions there is provided a vehicle including:
a platform having opposing first and second connecting ends, opposing lateral sides and an upper support surface for supporting a rider;
a pair of primary wheel assemblies pivotally connected to the first connecting end of the platform such that the primary wheel assemblies are laterally spaced
and pivotal relative to the platform about respective primary wheel assembly pivot axes passing longitudinally through the opposing connecting ends of the platform;
   at least one secondary wheel assembly pivotally connected to the second connecting end of the platform such that the at least one secondary wheel assembly is pivotal relative to the platform about a secondary wheel assembly pivot axis passing longitudinally through the opposing ends of the platform, the secondary wheel assembly pivot axis being parallel with the primary wheel assembly pivot axes;
at least one transverse connector pivotally connected to the primary wheel assemblies such that the primary wheel assemblies are pivotal relative to the transverse connector about respective co-planar transverse connector axes, being parallel with and spaced from the primary wheel assembly pivot axes, wherein the transverse connector lies transversely relative to the primary pivot axes and constrains the primary wheel assemblies to a synchronous lateral tilting movement relative to the platform; and
at least one longitudinal connector rigidly connecting the at least one secondary wheel assembly to: (i) at least one of the primary wheel assemblies; or (ii) a post connector pivotally connected to the first connecting end of the platform and to the transverse connector; such that the secondary wheel assembly is constrained by the longitudinal connector to a lateral tilting movement synchronous with the primary wheel assemblies;
characterised in that first and second connecting ends of the platform delimit a longitudinal platform span, longitudinally outside of which the wheel assemblies lie such that at least the upper support surface of the lateral sides of the platform are clear from obstruction to enable lateral step-on entry onto the platform by the rider from either lateral side thereof.

Typically, each of the primary wheel assemblies comprises at least a primary support post pivotally connected to the platform, a primary fork pivotally supported on the primary support post and a primary through axle mounted across the primary fork on which a primary wheel is rotatably mounted on the primary fork.

Generally, the at least one secondary wheel assembly comprises at least a secondary support post pivotally connected to the platform, a secondary fork pivotally supported on the secondary support post and a secondary through axle mounted across the secondary fork on which a secondary wheel is rotatably mounted on the secondary fork, such that the vehicle is supportable on a surface by the primary and secondary wheels.

Preferably, the primary and secondary wheel assemblies further comprise one or more springs and/or dampers for damping vibrations to the respective primary and secondary support posts.

More preferably, the primary wheel assemblies further comprise a support beam extending longitudinally from the primary support post such that the primary support post lies at or near a first end of the support beam, the support beam being rigidly connected to or integral with the primary support post to co-operatively form a substantially L-shaped support frame, with the platform pivotally supported along the span of the support beam thereof.

In one embodiment of the support beam, the support beam is a pivot shaft sized and shaped to pass through a respective corresponding pivot bore defined through the platform and extending across the connecting ends thereof, such that the respective primary wheel assembly pivot axis passing centrally through the pivot shaft and corresponding pivot bore is located at or near each of the lateral sides of the platform. In an alternative embodiment of the support beam, the support beam comprises a support lug located at or near a second end of the support beam such that the platform is pivotally supported between the primary support post and the support lug on one or more pivot shafts extending between the primary support post, the support lug and the respective connecting ends of the platform, such that the respective primary wheel assembly pivot axis passing centrally through the pivot shaft and corresponding pivot bores, defined in one or the other of the primary support post, support lug or connecting ends of the platform, is located at or near each of the lateral sides of the platform.

The platform and the support frame are typically configured such that the primary wheel assembly pivot axes, relative to the surface on which the vehicle is a supportable by the wheels, lies beneath the upper support surface of the platform.

Preferably, the platform lies over the support beams of the laterally spaced support frames such that at least the upper support surface of the lateral sides of the platform are clear from obstruction to enable lateral step-on entry onto the platform by the rider from either lateral side of thereof.

The vehicle generally also includes a drive for driving one or more of the primary or the secondary wheels, wherein the drive comprises one or more of: (i) an electric motor, a power source, a transmission and a controller; or (ii) an internal combustion engine, fuel tank for delivering fuel to the engine and a transmission. Most preferably, the drive is located on the vehicle longitudinally outside of the longitudinal platform span, such that the upper support surface of the platform is substantially clear from obstruction to enable the rider to laterally step over the platform from one lateral side to the other.

In a first three-wheeler configuration, the vehicle has:
the opposing first and second connecting ends of the platform as respective rear and front connecting ends thereof;
the primary wheel assemblies as rear wheel assemblies thereof, wherein at least one of the primary wheel assemblies has the electric motor mounted thereon thereby enabling the electric motor to tilt synchronously with the primary wheel assemblies, and further wherein the post connector is located centrally between the primary support posts of the primary wheel assemblies, with the at least one transverse connector pivotally connected between the post connector and the primary support posts of the primary wheel assemblies; and
the secondary wheel assembly as a front wheel assembly thereof, wherein the longitudinal connector rigidly connects the post connector to the secondary support post of the secondary wheel assembly, and further wherein the secondary wheel assembly is steerable via a steering column pivotally supported on the secondary support post via a steering mount thereby enabling the steering column to tilt synchronously with the secondary support post, the steering column supporting a handle bar at or near an upper end thereof and the secondary fork, through axle and wheel at or near a lower end thereof, such that the secondary wheel is steerable left-and-right about a steering axis passing through the steering column and substantially diametrically through the secondary wheel.

The power source and/or the fuel tank may be mounted rigidly to the platform, longitudinally beyond the longitudinal platform span, thereby to prevent any relative movement between the power source and/or the fuel tank and the platform. Alternatively the power source and/or the fuel tank are mounted to the post connector enabling the power source and/or the fuel tank to tilt with the post connector relative to the platform.

Preferably, a seat is mounted on the post connector by a seat post. More preferably, the seat and/or seat post are removable to convert the vehicle between respective stand-on or sit-stand vehicle configurations.

In a second three-wheeler configuration, the vehicle has:
the opposing first and second connecting ends of the platform as respective front and rear connecting ends thereof;
the primary wheel assemblies as steerable front wheel assemblies thereof;
   wherein the post connector is located centrally between the primary support posts of the primary wheel assemblies with the at least one transverse connector pivotally connected between the post connector and the primary support posts of the primary wheel assemblies, the post connector pivotally supporting a steering column via a steering mount thereon with the steering column supporting a handle bar at or near an upper end thereof and a steering bracket at or near a lower end thereof thereby enabling the steering column to tilt synchronously with the post connector; and
   further wherein primary steering tubes are pivotally supported on each of the primary support posts thereby enabling the primary steering tubes to tilt synchronously with the primary support posts, with each of the primary steering tubes supporting the primary fork, through axle and wheel at or near a lower end thereof and being connected by tie rods to the steering bracket at or near an upper end thereof, such that the primary wheels are steerable left-and-right about respective steering axes passing through the respective steering tube and substantially diametrically through the respective primary wheel; and
the secondary wheel assembly as a rear wheel assembly thereof, wherein the longitudinal connector rigidly connects the post connector to the secondary support post of the secondary wheel assembly, and further wherein the electric motor is mounted on the secondary wheel assembly thereby enabling the electric motor to tilt synchronously with the secondary wheel assembly.

The power source and/or the fuel tank may be mounted rigidly to the platform, longitudinally beyond the longitudinal platform spam, thereby to prevent any relative movement between source and/or the fuel tank and platform. Alternatively, the power source and/or fuel tank are mounted to the secondary support post enabling the power source and/or the fuel tank to tilt with the secondary support post relative to the platform.

Preferably, a seat is mounted on the secondary support post by a seat post. More preferably, the seat and/or seat post are removable to convert the vehicle between respective stand-on or sit-stand vehicle configurations.

In a four-wheeler configuration, the vehicle has:
the opposing first and second connecting ends of the platform as respective front and rear connecting ends thereof;
the primary wheel assemblies as steerable front wheel assemblies thereof;
   wherein the post connector is located centrally between the primary support posts of the primary wheel assemblies with the at least one transverse connector pivotally connected between the post connector and the primary support posts of the primary wheel assemblies, the post connector pivotally supporting a steering column via a steering mount thereon with the steering column supporting a handle bar at or near an upper end thereof and a steering bracket at or near a lower end thereof thereby enabling the steering column to tilt synchronously with the post connector; and
   further wherein primary steering tubes are pivotally supported on each of the primary support posts thereby enabling the primary steering tubes to tilt synchronously with the primary support posts, with each of the primary steering tubes supporting the primary fork, through axle and wheel at or near a lower end thereof and being connected by tie rods to the steering bracket at or near an upper end thereof, such that the primary wheels are steerable by the steering column left-and-right about respective steering axes passing through the respective steering tube and substantially diametrically through the respective primary wheel; and
a pair of the secondary wheel assemblies as rear wheel assemblies thereof,
   wherein the primary wheel assembly pivot axis of each of the primary wheel assemblies is co-axial with one of the secondary wheel assembly pivot axis of the respective secondary wheel assembly, and
   further wherein the longitudinal connector is the support beam rigidly connecting between the respective primary and secondary support posts, with the secondary support post replacing the support lug and with at least one of the secondary wheel assemblies having the electric motor mounted thereon thereby enabling the electric motor to tilt synchronously with the primary and the secondary wheel assemblies.

The power source and/or the fuel tank may be mounted rigidly to the platform, longitudinally beyond the longitudinal platform span, thereby to prevent any relative movement between power source and/or the fuel tank and the platform.

Generally, the vehicle includes a seat post having a seat mounted thereon, the seat post being pivotally mounted centrally to the second connecting end of the platform and rigidly connected to the post connector by a secondary longitudinal connector thereby enabling the seat post to tilt synchronously with the post connector.

Typically, the power source and/or the fuel tank are mounted to a seat post having a seat mounted thereon, the seat post being pivotally mounted centrally to the second connecting end of the platform and rigidly connected to the post connector by a secondary longitudinal connector thereby enabling the seat post to tilt synchronously with the post connector.

The seat and/or seat post are preferably removable to convert the vehicle between respective stand-on or sit-stand vehicle configurations.

More preferably, the one or more transverse connectors, the platform, the primary support posts, the secondary support post and the post connector are pivotally connected such that throughout the tilting movement range of the vehicle:
the transverse connectors and the platform remain parallel to one another; and
the primary support posts, the secondary support post and the post connector, and consequentially the primary and the secondary wheels, remain parallel to one another.

Generally, the secondary wheel assembly pivot axis/axes is co-planar with the respective primary wheel assembly pivot axes, and further wherein the handle bar includes a throttle control, for controlling the output of the drive and consequentially the speed of the vehicle, and at least one brake control, for controlling brakes co-operative with the primary and secondary wheels.

Typically, the ratio of:
the handle bar height to the primary wheel assembly pivot axes, measured from the surface on which the vehicle is supportable, is between about 4:1 and 6:1; and
the seat height to the primary wheel assembly pivot axes, measured from the surface on which the vehicle is supportable, is between about 3:1 and 4:1.

Preferably, the longitudinal connector or the secondary longitudinal connector extends across the longitudinal platform span of the platform either beneath the platform, through the platform or over the platform no higher than 25 millimetres above the upper support surface thereof, such that other than the longitudinal connector passing over the platform, the upper support surface of the platform is unobstructed to enable the rider to laterally step over and through the platform from one lateral side to the other.

The vehicle is preferably a stand-on only, or combination sit-on or stand-on vehicle.

### BRIEF DESCRIPTION OF THE FIGURES

The invention will now be described in more detail, by way of example only, with reference to the accompanying illustrations, in which:

FIG. 1 is a top perspective view of a first three-wheeler configuration of a vehicle in accordance with the present invention;

FIG. 2 is a bottom perspective view of the vehicle of FIG. 1;

FIG. 3 is a top view of the vehicle of FIG. 1;

FIG. 4 is a side view of the vehicle of FIG. 1;

FIG. 5 is a rear view of the vehicle of FIG. 1;

FIG. 6 is a bottom view of the vehicle of FIG. 1;

FIG. 7 is a front view of the vehicle of FIG. 1, tilted during a cornering manoeuvre;

FIG. 8 is a front view of the vehicle of FIG. 1, as it riding along a slope;

FIG. 9 is a top perspective view of a second three-wheeler configuration of a vehicle in accordance with the present invention;

FIG. 10 is a bottom perspective view of the vehicle of FIG. 9;

FIG. 11 is a side view of the vehicle of FIG. 9;

FIG. 12 is a rear view of the vehicle of FIG. 9;

FIG. 13 is a front view of the vehicle of FIG. 9;

FIG. 14 is a top view of the vehicle of FIG. 9;

FIG. 15 is a bottom view of the vehicle of FIG. 9;

FIG. 16 is a front view of the vehicle of FIG. 9, tilted during a cornering manoeuvre;

FIG. 17 is a front view of the vehicle of FIG. 9, as it riding along a slope;

FIG. 18 is a top perspective view of a third four-wheeler configuration of a vehicle in accordance with the present invention;

FIG. 19 is a bottom perspective view of the vehicle of FIG. 18;

FIG. 20 is a side view of the vehicle of FIG. 18;

FIG. 21 is a top view of the vehicle of FIG. 18;

FIG. 22 is a front view of the vehicle of FIG. 18;

FIG. 23 is a rear view of the vehicle of FIG. 18;

FIG. 24 is a bottom view of the vehicle of FIG. 18;

FIG. 25 is a front view of the vehicle of FIG. 18, tilted during a cornering

manoeuvre; and

FIG. 26 is a front view of the vehicle of FIG. 18, as it riding along a slope.

### DETAILED DESCRIPTION OF THE INVENTION

A first three-wheeler configuration of a vehicle according to a preferred embodiment of the invention is designated generally in the accompanying Figures by reference numeral 10. The vehicle 10 comprises a platform 12, a pair of primary wheel assemblies 30 and a secondary wheel assembly 70.

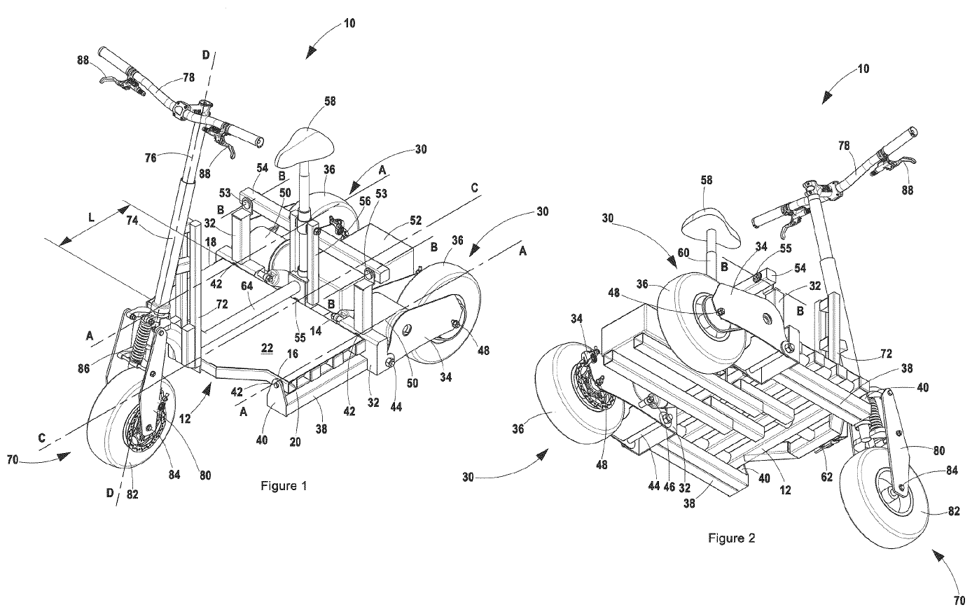

With reference to FIG. 1 and FIG. 2, the platform 12 comprises opposing first and second connecting ends 14, 16, opposing lateral sides 18, 20 and an upper support surface 22 for supporting a rider (not shown), specifically the feet of the rider, thereon. Although the platform 12 may be made in many different ways, in the accompanying illustrations the platform 12 is made from a grid of tubular members with a plate extending over the upper support surface 22 thereof.

In this configuration, it will be appreciated that the primary wheel assemblies 30 are rear wheel assemblies, the secondary wheel assembly 70 is a front wheel assembly and the opposing first and second connecting ends 14, 16 of the platform 12 are respective rear and front ends of thereof.

Each of the primary wheel assemblies 30 are pivotally connected to the first connecting end 14 of the platform 12 such that the primary wheel assemblies 30 are laterally spaced from one another across a width dimension of the vehicle 10, and pivotal relative to the platform 12 about respective primary wheel assembly pivot axes A-A passing longitudinally through the opposing connecting ends 14, 16 of the platform 12, across a length dimension of the vehicle 10.

Each of the primary wheel assemblies 30 comprises at least a primary support post 32, a primary fork 34 and a primary wheel 36. Furthermore, each of the primary wheel assemblies 30 further comprise a support beam 38 extending longitudinally, at a first end thereof, from the primary support post 32 such that the primary support post 32 and the support beam 38 co-operatively form a substantially L-shaped support frame.

The support beam 38 is integral with or rigidly connected to the primary support post 32, spans beneath the lateral side 20 of the platform 12 and comprises, at or near a second end thereof, a support lug 40 extending upwardly from the support beam 38. It is between such support lug 40 and the primary support post 32 that the platform 12 is pivotally supported on the L-shaped support frame 32, 38 by one or more pivots shafts 42 extending thereacross.

In this manner, the primary wheel assembly pivot axes A-A, passing centrally through the pivot shaft 42 and corresponding pivot bores (not shown), are respectively located at or near each of the lateral sides 18, 20 of the platform 12.

The primary fork 34, of each of the primary wheel assemblies 30, is pivotally connected to the primary support post 32 by pivot 44, in a motorcycle swing arm fashion, with a spring and/or damper 46 connected between the support post 32 and the primary fork 36 to damp out ride vibrations. The primary wheel 36 is rotatably mounted on the primary fork 34 by a primary through axle 48 extending across the primary fork 36.

It will be appreciated that different types of drives may power the vehicle 10. In the illustrated Figures, the drive is electric made up of an electric motor 50 and transmission mounted on each of the primary wheel assemblies 30, a power source in the form of batteries 52 mounted to the platform 12 and a controller (not shown).

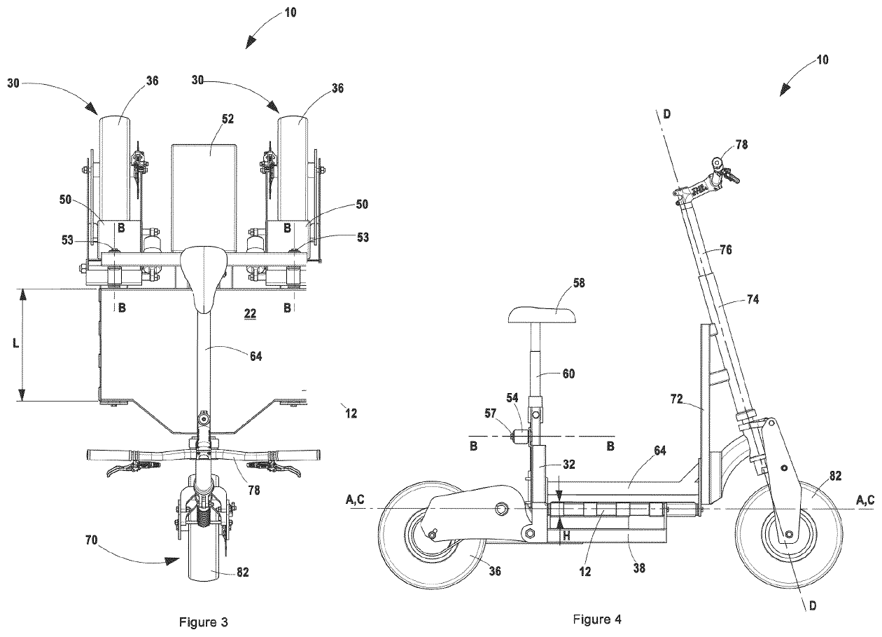

With reference also to FIG. 3, it will be appreciated further that the electric motors 50 and the power source 52 are mounted longitudinally beyond and outside of a longitudinal platform span L, delimited by first and second connecting ends 14, 16 of the platform 12. By mounting the electric motors 50 on the primary wheel assemblies 30, thereby enabling the electric motors 50 to synchronously tilt with the primary wheel assemblies 30, transmission alignment between the electric motors 50 and the primary wheels 36 becomes simplified.

From the accompanying illustrations, it will be appreciated that the power source 52 is rigidly mounted to the platform 12 and as such, orientates together with the platform 12, the significance of which will be expanded on later in this specification.

The vehicle 10 includes at least one transverse connector 54, lying transversely and more particularly perpendicularly across the primary wheel assembly pivot axes A-A. Furthermore, the transverse connector 54 is pivotally connected at or near its opposing ends to one of the respective support posts 32 by respective pivot shafts 53 such that the primary wheel assemblies 30 are pivotal relative to the transverse connector 54 about respective co-planar transverse connector axes B-B, being parallel with and spaced from the primary wheel assembly pivot axes A-A, as best illustrated in FIG. 4.

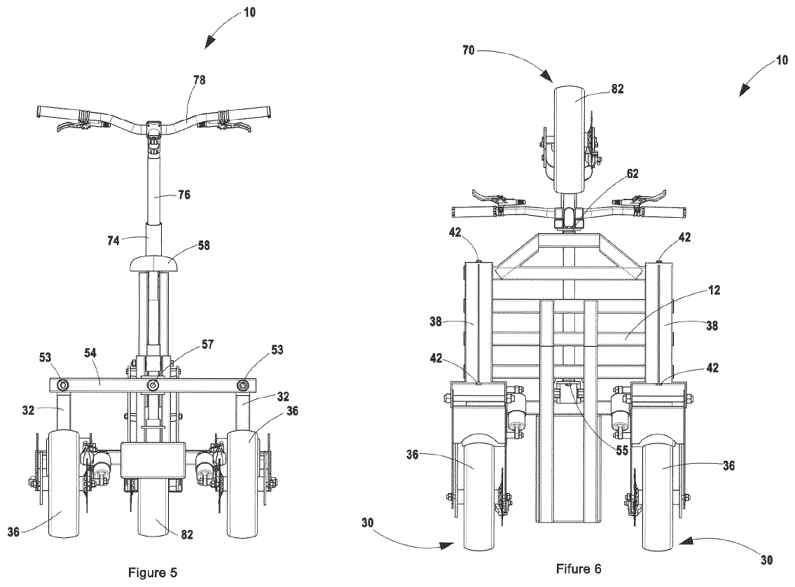

With the primary wheel assemblies 30 pivotally connected to one another by the transverse connector 54, the primary wheel assemblies 30 are constrained to a synchronous lateral tilting movement relative to the platform 12. Furthermore, the vehicle 10 includes a post connector 56 pivotally connected at one end by a pivot shaft 55 to the first connecting end 14 of the platform 12 and at a secondary location along its span to the transverse connector 54 by a pivot shaft 57 as best illustrated in FIG. 5.

The post connector 56 is centred between the support posts 32 of the primary wheel assemblies 30, and has a seat 58 mounted thereon by a seat post 60, which is preferably height adjustable.

As such, the post connector 56 is pivotal relative to the platform 12 about a central axis passing longitudinally through the opposing connecting ends 14, 16 of the platform 12, which central axis is a secondary wheel assembly pivot axis C-C, which is parallel and co-planar with the primary wheel assembly pivot axes A-A, and about which the secondary wheel assembly 70 is pivotal relative to the platform 12.

With reference now also to FIG. 6, the secondary wheel assembly 70 is pivotally connected centrally to the second connecting end 16 of the platform 12 by a pivot shaft 62 passing therebetween, and rigidly connected to the post connector 56 by a longitudinal connector 64 passing across the longitudinal platform span L.

In this manner, the secondary wheel assembly 70 is constrained, via connection to the longitudinal connector 64 and the post connector 56, to a lateral tilting movement synchronous with the primary wheel assemblies 30.

Furthermore, with the longitudinal connector 64 passing centrally over the platform 12, at least the upper support surfaces of the lateral sides 18, 20 of the platform 12 are clear from obstruction to enable lateral step-on entry onto the platform 12 by the rider from either lateral side 18, 20 thereof.

By restricting the longitudinal connector 64 to being the only component passing over the platform 12, at a height of no more than 25 millimetres above the upper surface 22 thereof, the entire upper support surface 22 of the platform is largely unobstructed to enable the rider to laterally step over and through the platform 12 from one lateral side 18, 20 to the other.

The secondary wheel assembly 70 comprises a secondary support post 72, which is the part of the secondary wheel assembly 70 that is pivotally connected to the second connecting end 16 of the platform 12. Connected to the secondary support post 72 is a steering mount 74 through which a steering column 76 to rotatably supported on the secondary support post 72 such that the thereby enabling the steering column 76 to tilt synchronously with the secondary support post 72.

The steering column 76 supports a handle bar 78 at or near an upper end thereof and a secondary fork 80 on which a secondary wheel 82 is rotatably supported by a secondary through axle 84, with a spring and/or damper 86 connected between the steering mount 74 and the secondary fork 80 to damp out ride vibrations. In this manner, the secondary wheel 82 is steerable left-and-right about a steering axis D-D passing through the steering column 76 and substantially diametrically, that is diametrically or near diametrically (i.e. through a large portion of the wheel), through the secondary wheel 82.

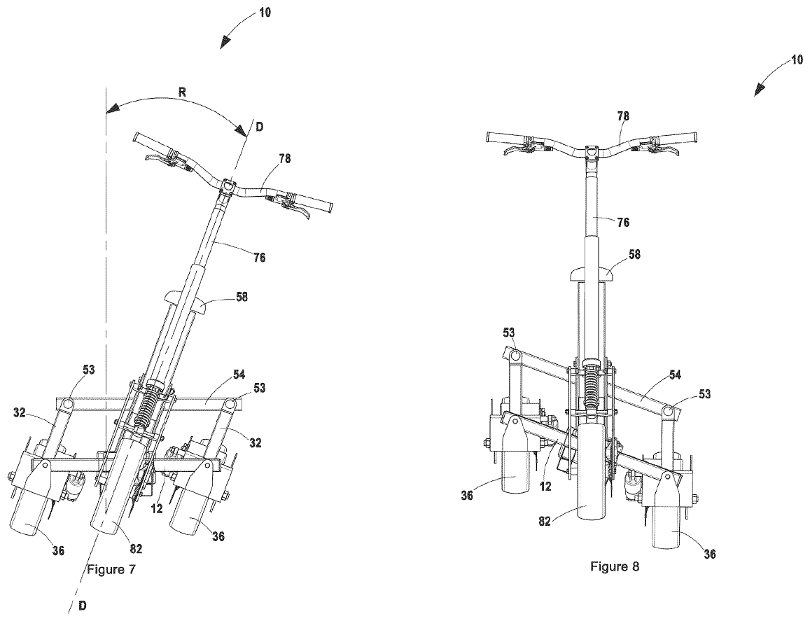

As illustrated in FIG. 7, with the transverse connector 54, the platform 12, the primary support posts 32, the secondary support post 72 and the post connector 56 pivotally connected as described and illustrated, it will be appreciated that throughout the tilting movement range R of the vehicle 10, the transverse connector 54 and the platform 12 are constrained to remain parallel to one another, while the steering column 76, primary wheels 36 and the secondary wheel 82 tilt synchronously relative to the platform 12.

In essence, at least the secondary wheel assembly 70, the longitudinal connector 64 and the post connector 56 together form a central tilt control frame, flanked on either side by the primary wheel assemblies 30. Either in a standing or a seated position on the platform 12, the rider is capable of applying a leveraged leaning force to the central tilt control frame via the handle bar 78 and/or seat 58, which is transmittable to a synchronous tilting movement of the primary wheel assemblies 30, together with the secondary wheel assembly 70, via the transverse connector 54.

It will be appreciated that by raising the handle bar 78 and/or the seat 58 to a height greater than the typical handle bar and seat heights found on existing motorcycle-type vehicles, the rider leverage effect is greatly increased providing the rider with full physical lean and tilt control of the vehicle while moving forward, reversing or coming to a standstill, all the while retaining the normal riding characteristics and sensations that are experienced when riding a conventional two-wheeled motorcycle or scooter.

The position of the components of the drive on the vehicle 10 further increase the leverage effect the rider is capable of transmitting thereto. For example, with the weight of the power source 52 rigidly connected to the platform 12 as illustrated, the platform 12 is better stabilised against which the rider can apply the leaning force.

Alternatively, and as will be described with reference to other configurations of the vehicle later in the specification, the power source 52 could be mounted to the post connector 56 to provide additional weight for assisting the leaning the vehicle 10. By constructing the vehicle 10 such that the primary wheel assembly pivot axes A-A are as close to the ground as possible, it will be appreciated that the total laterally leaned or tilted vehicle weight to be manipulated by the rider becomes less, further assisting the rider to physically control the tilting of the vehicle 10.

To optimize lateral lean or tilt control, and to gain advantage from the lever principal (in this case a complex class 2 type lever), the design of the vehicle 10 takes into consideration the following factors: (i) the height of the handle bar 78 measured from the primary wheel assembly pivot axes A-A; (ii) the position of the overall load relative to the primary wheel assembly pivot axes A-A; and (iii) the position of the lever's fulcrum, which in this case is the contact point between the wheels 36, 82 and the surface on which the vehicle is supportable (i.e. a road surface).

Based on this optimal design, the ideal proportions of the vehicle 10, represented as ratios, are set out below:
the ratio of the handle bar height to the primary wheel assembly pivot axes A-A, measured from the surface on which the vehicle is supportable, is between about 4:1 and 6:1; and
the ratio of the seat height to the primary wheel assembly pivot axes A-A, measured from the surface on which the vehicle is supportable, is between about 3:1 and 4:1.

The optimal dimensions of the vehicle 10, relative to a wheel diameter of 300 millimetres and based on the ratios set out above, are as follows:
the primary wheel assembly pivot axes A-A, measured from the surface on which the vehicle is supportable, is about 200 millimetres;
the height of the handle bars, measured from the surface on which the vehicle is supportable, is about 1200 millimetres (about 320 millimetres higher than the handle bar height of typical scooters or motorcycles); and
the height of the seat, measured from the surface on which the vehicle is supportable, is about 920 millimetres (about 280 millimetres higher than the seat height of typical scooters or motorcycles).

It will be appreciating that the vehicle 10 can be manufactured in many different sizes, and that the handle bar and seat heights may be adjustable to accommodate riders of different heights. Furthermore, the leverage ratios will vary and are applicable to specific differing preferred vehicle platform heights as measured from the road surface. As a general rule, the lower the primary wheel assembly pivot axes A-A relative to the road surface, for a given handle bar height, the more the mechanical advantage and the easier it becomes for the rider to tilt or lean the vehicle 10. Generally, smaller diameter wheels also provide for easier manipulation of the vehicle 10 while the ride overall is less smooth, larger diameter wheels are more difficult to manipulate but provide a smoother overall ride.

Further control is provided to the rider by including a throttle (not shown, but preferably a twist grip or a thumb lever) for controlling the output of the drive and consequentially the speed of the vehicle 10, and at least one brake control 88 for controlling brakes co-operative with the primary and secondary wheels 36, 82, typically being in the form of disc brakes on-board the primary and secondary wheels 36, 82.

In use, and with reference to FIG. 7 showing the vehicle 10 during a cornering manoeuvre, the rider leans into the corner by shifting his/her bodyweight laterally, causing the central tilt control frame to tilt from the vertical towards the inside of the corner by angle R.

Consequentially, the primary and the secondary wheel assemblies 30, 70 tilt towards the inside of the corner, causing the camber angle of the wheels 36, 82 to change. It will be appreciated that the change in camber angle together with the shifting of the rider's centre of gravity to the inside of the corner facilitate effective cornering of the vehicle 10. When exiting the corner, the rider leans in the opposite direction, bringing the central tilt control frame and consequentially the primary and the secondary wheel assemblies 30, 70 back to their respective upright conditions.

Furthermore the tilt-enabling construction and independent suspension of the vehicle 10 are advantageous for off-roading applications. This is best illustrated with reference to FIG. 8, in which the vehicle 10 is shown as if riding along a slope. Despite the slope angle, the steering column 76 and handle bar 78, as well as the seat 58 remain substantially upright, which retains the rider in a substantially upright position thereby reducing the possibility of the vehicle 10 tipping over down the slope.

The vehicle 10 has many further advantages. For example, by moving the primary wheel assembly support of the platform 12, specifically the support beam 38 thereof, to an underside of the platform 12, there are no parts of the primary wheel assembly 30 located above the platform 12, which would otherwise interfere with the rider's feet, particularly while corning or riding along a slope. This makes the vehicle 10 of the present invention safer than many other existing tilting or leaning vehicles.

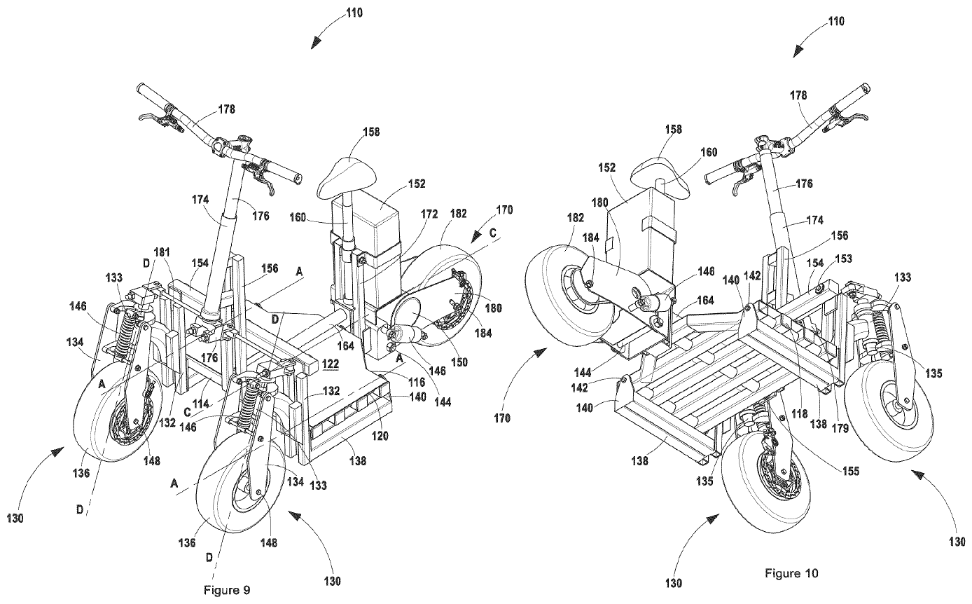

FIG. 9 to 17 illustrate a second three-wheeler configuration of the vehicle 110, with like references designating like parts. In this configuration, it will be appreciated that the primary wheel assemblies 130 are steerable front wheel assemblies, the secondary wheel assembly 170 is a rear wheel assembly and the opposing first and second connecting ends 114, 116 of the platform 112 are respective front and rear ends of thereof.

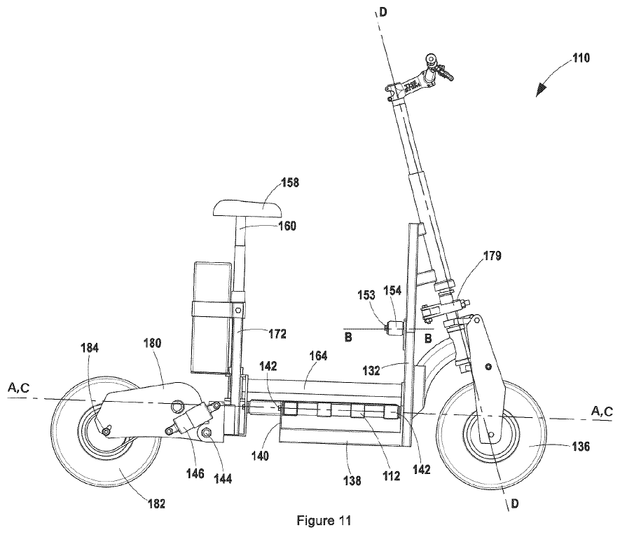

With reference specifically to FIG. 9 and FIG. 10, each of the primary wheel assemblies 130 are pivotally connected to the first connecting end 114 of the platform 112, and pivotal relative to the platform 112 about respective primary wheel assembly pivot axes A-A passing longitudinally through the opposing connecting ends 114, 116 of the platform 112, and near the lateral sides 118, 120 thereof.

Each of the primary wheel assemblies 130 comprises at least a primary support post 132, a primary fork 134 and a primary wheel 136. Furthermore, each of the primary wheel assemblies 130 further comprise a support beam 138 extending longitudinally, at a first end thereof, from the primary support post 132 such that the primary support post 132 and the support beam 138 co-operatively form a substantially L-shaped support frame.

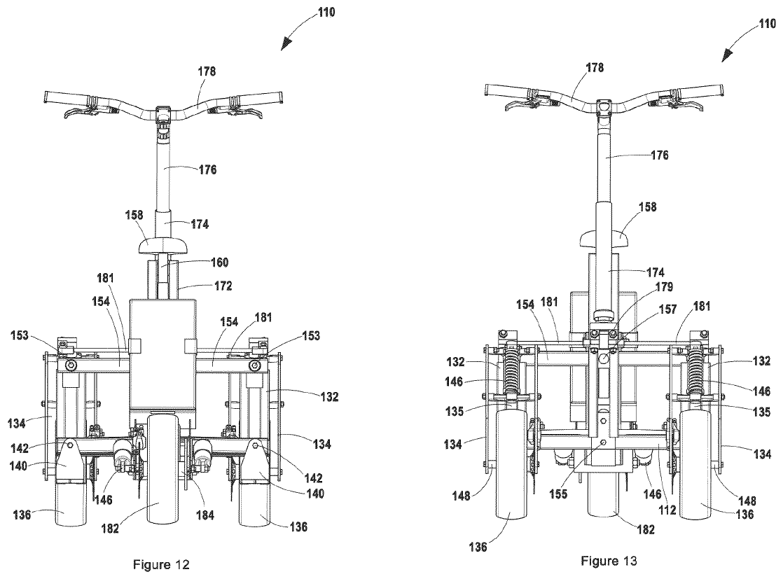

With reference also to FIG. 11 and FIG. 12, the support beam 138 is integral with or rigidly connected to the primary support post 132, spans beneath the lateral side 120 of the platform 112 and comprises, at or near a second end thereof, a support lug 140 extending upwardly from the support beam 138. It is between such support lug 140 and the primary support post 132 that the platform 112 is pivotally supported on the L-shaped support frame 132, 138 by one or more pivots shafts 142 extending thereacross.

Connected to each of the primary support posts 132 is a primary steering mount 133 through which a primary steering tube 135 is rotatably supported on the respective primary support post 132, such that the primary steering tubes 135 are pivotally supported on each of the primary support posts 132 thereby enabling the primary steering tubes 135 to tilt synchronously with the primary support posts 132.

With reference now also to FIG. 13, each of the primary steering tubes 135, at or near a lower end thereof, support the primary fork 134, on which the primary wheel 136 is rotatably mounted by a primary through axle 148, with a spring and/or damper 146 connected between the steering mount 133 and the primary fork 134 to damp out ride vibrations.

In this manner, the primary wheels are steerable left-and-right about respective steering axes D-D passing through the respective primary steering tubes 135 and substantially diametrically through the respective primary wheel 136.

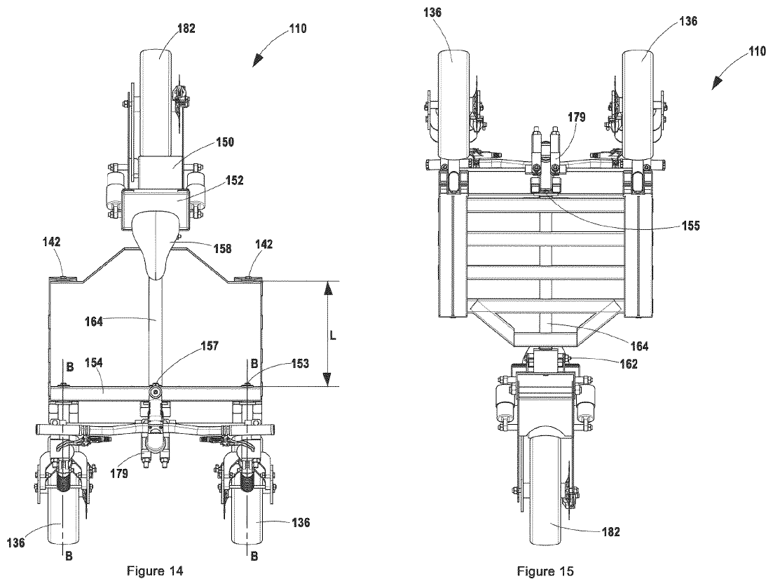

With reference also to FIG. 14, the vehicle 110 includes at least one transverse connector 154, lying transversely and more particularly perpendicularly across the primary wheel assembly pivot axes A-A. Furthermore, the transverse connector 154 is pivotally connected at or near its opposing ends to one of the respective support posts 132 by respective pivot shafts 153 such that the primary wheel assemblies 130 are pivotal relative to the transverse connector 154 about respective co-planar transverse connector axes B-B, being parallel with and spaced from the primary wheel assembly pivot axes A-A.

With the primary wheel assemblies 130 pivotally connected to one another by the transverse connector 154, the primary wheel assemblies 130 are constrained to a synchronous lateral tilting movement relative to the platform 112. Furthermore, the vehicle 110 includes a post connector 156 pivotally connected at one end by a pivot shaft 155 to the first connecting end 114 of the platform 112 and at a secondary location along its span to the transverse connector 154 by a pivot shaft 157 as best illustrated in FIG. 15.

The post connector 156 is centred between the primary support posts 132 of the primary wheel assemblies 130. Connected to the post connector 156 is a further steering mount 174 through which a steering column 176 is rotatably supported on the post connector 156 thereby enabling the steering column 176 to tilt synchronously with the post connector 156.

As such, the post connector 156 is pivotal relative to the platform 112 about a central axis passing longitudinally through the opposing connecting ends 114, 116 of the platform 12, which central axis is a secondary wheel assembly pivot axis C-C, which is parallel and co-planar with the primary wheel assembly pivot axes A-A, and about which the secondary wheel assembly 170 is pivotal relative to the platform 112.

The steering column 176 supports a handle bar 178 at or near an upper end thereof and a steering bracket 179 at or near a lower end thereof, to which steering bracket 179 an upper end of the primary steering tubes are pivotally connected by tie rods 181. In this manner, the primary wheels 136 are steerable left-and-right about their respective steering axes D-D via a left-and-right rider applied steering action to the handle bar 178.

It will be appreciated that the tie rods 181 are arranged in a manner similar to that of steering linkages of conventional automobiles so tat the respective primary wheels 136 turn about different respective radii during low-speed cornering.

With reference specifically to FIG. 10, FIG. 12 and FIG. 15, a secondary support post 172 of the secondary wheel assembly 170 is pivotally connected centrally to the second connecting end 116 of the platform 112 by a pivot shaft 162 passing therebetween, and rigidly connected to the post connector 156 by a longitudinal connector 164 passing across the longitudinal platform span L, delimited by first and second connecting ends 114, 116 of the platform 112.

In this manner, the secondary wheel assembly 170 is constrained, via connection to the longitudinal connector 164 and the post connector 156, to a lateral tilting movement synchronous with the primary wheel assemblies 130.

The secondary wheel assembly 170 further comprises a secondary fork 180 pivotally connected to the secondary support post 172 by pivot 144, in a motorcycle swing arm fashion, with a spring and/or damper 146 connected between the secondary support post 172 and the secondary fork 180 to damp out ride vibrations.

A secondary wheel 182 is rotatably mounted on the secondary fork 180 by a secondary through axle 184 extending across the secondary fork 180. Furthermore, a seat 158 is mounted on the secondary support post 172 by a seat post 160, which is preferably height adjustable.

The drive of the vehicle 110, made up of an electric motor 150 and transmission mounted, a power source in the form of batteries 152 and a controller (not shown), is mounted on the secondary wheel assemblies 170, longitudinally beyond and outside of the longitudinal platform span L.

By mounting the drive on the secondary wheel assemblies 170, thereby enabling the drive to synchronously tilt with the secondary wheel assemblies 170, transmission alignment between the electric motor 150 and the secondary wheel 182 becomes simplified.

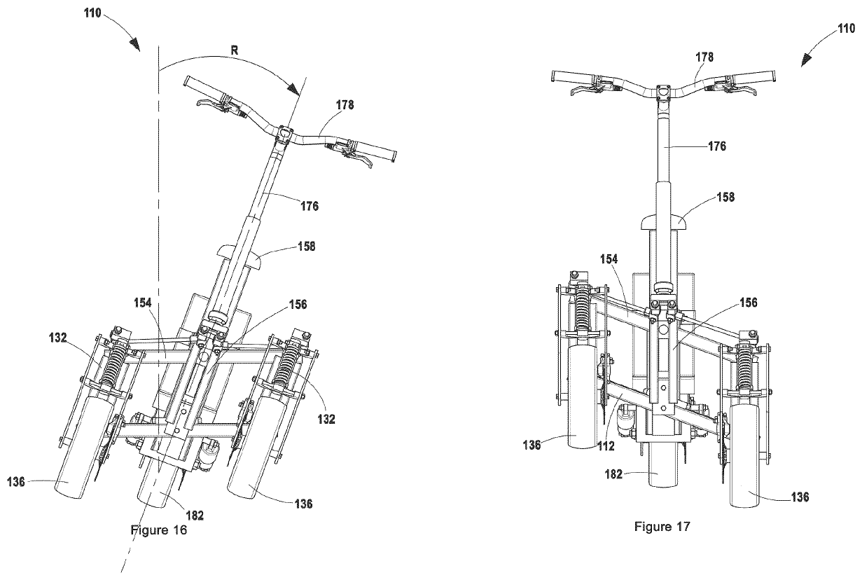

With reference also to FIG. 16, showing the vehicle 110 during a cornering manoeuvre, and FIG. 17, showing the vehicle 110 as if riding along a slope, it will be appreciated that with the transverse connector 154, the platform 112, the primary support posts 132, the secondary support post 172 and the post connector 156 pivotally connected as described and illustrated, the transverse connector 154 and the platform 112 are constrained to remain parallel to one another throughout the tilting movement range R of the vehicle 110. All the while, the steering column 176, primary wheels 136 and the secondary wheel 182 tilt synchronously relative to the platform 112.

In essence, at least the secondary wheel assembly 170, the longitudinal connector 164 and the post connector 156 together form a central tilt control frame, flanked on either side by the primary wheel assemblies 130.

Either in a standing or a seated position on the platform 112, the rider is capable of applying a leveraged leaning force to the central tilt control frame via the handle bar 178 and/or seat 158, which is transmittable to a synchronous tilting movement of the primary wheel assemblies 130, together with the secondary wheel assembly 170, via the transverse connector 154.

It will be appreciated that the characteristics, advantages and rider experience of this second configuration of the vehicle 110 is much the same as the characteristics, advantages and rider experience described in respect of the first configuration of the vehicle 10.

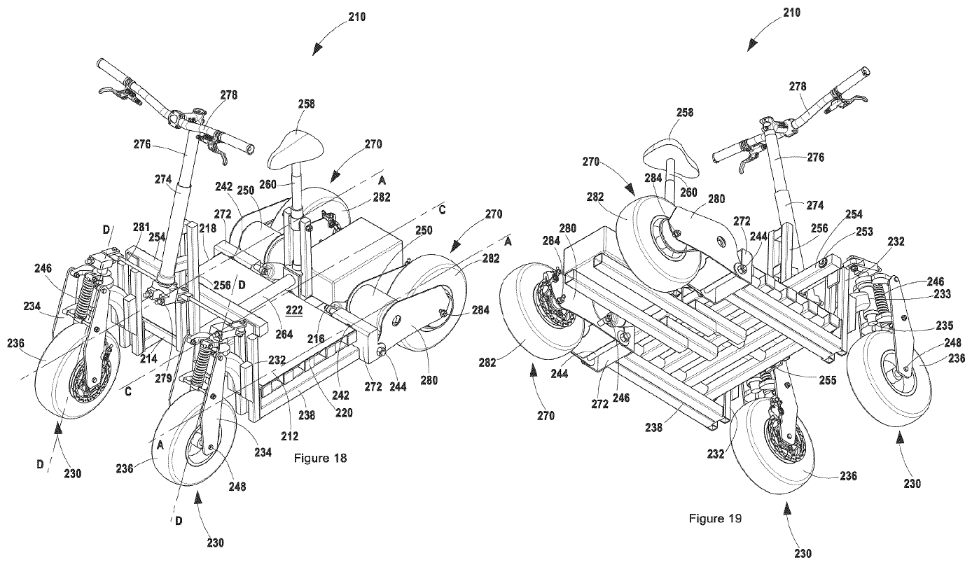

FIG. 18 to 26 illustrate a third configuration of the vehicle 210, with like references designating like parts. In this configuration, the vehicle 210 is a four-wheeler combining a rear end much the same as that of the first three-wheeler configuration vehicle 10, and a front end much the same as that of the second three-wheeler configuration vehicle 110.

With reference to FIG. 18 and FIG. 19, the primary wheel assemblies 230 are steerable front wheel assemblies, the secondary wheel assemblies 270 are rear wheel assemblies and the opposing first and second connecting ends 214, 216 of the platform 212 are respective front and rear ends of thereof.

Each the primary wheel assemblies 230 are pivotally connected to the first connecting end 214 of the platform 212, and pivotal relative to the platform 212 about respective primary wheel assembly pivot axes A-A passing longitudinally through the opposing connecting ends 214, 216 of the platform 212, and near the lateral sides 218, 220 thereof.

Each of the primary wheel assemblies 230 comprises at least a primary support post 232, a primary fork 234 and a primary wheel 236. Furthermore, each of the primary wheel assemblies 230 further comprise a support beam 238 extending longitudinally, at a first end thereof, from the primary support post 232 such that the primary support post 232 and the support beam 238 co-operatively form a substantially L-shaped support frame.

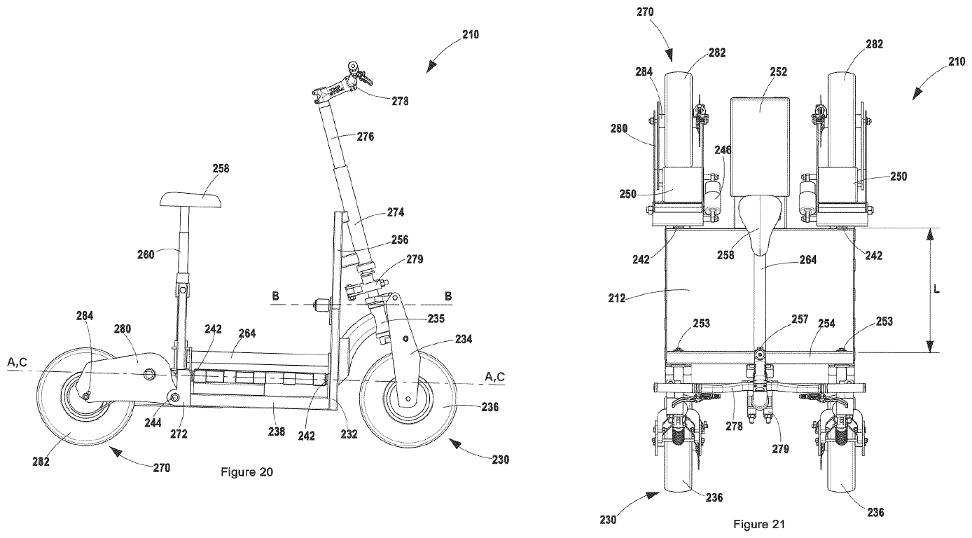

With reference also to FIG. 20 and FIG. 21, the support beam 238 is integral with or rigidly connected to the primary support post 232, spans beneath the lateral side 220 of the platform 212 and, at or near a second end thereof, is integral with or rigidly connected to the secondary support post 272, such that the substantially L-shaped support frame, made up from the support beam 238 and the primary support post 232, together with the secondary support post 272 form a substantially U-shaped support frame. It is between the primary support post 232 and the secondary support post 272 of the U-shaped support frame that one or more pivots shafts 242 pivotally support the platform 212.

Connected to each of the primary support posts 232 is a primary steering mount 233 through which a primary steering tube 235 is rotatably supported on the respective primary support post 232, such that the primary steering tubes 235 are pivotally supported on each of the primary support posts 232 thereby enabling the primary steering tubes 235 to tilt synchronously with the primary support posts 232.

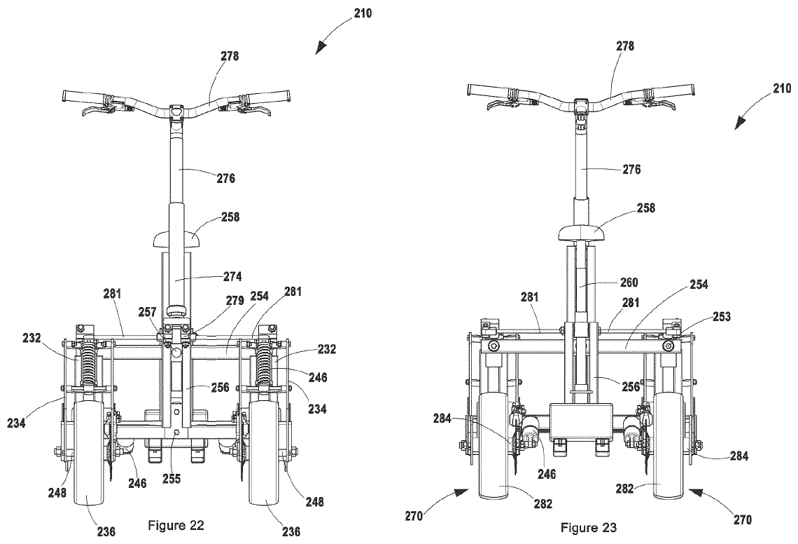

With reference now also to FIG. 22, each of the primary steering tubes 235, at or near a lower end thereof, support the primary fork 234, on which the primary wheel 236 is rotatably mounted by a primary through axle 248, with a spring and/or damper 246 connected between the steering mount 233 and the primary fork 234 to damp out ride vibrations.

In this manner, the primary wheels are steerable left-and-right about respective steering axes D-D passing through the respective primary steering tubes 235 and substantially diametrically through the respective primary wheel 236.

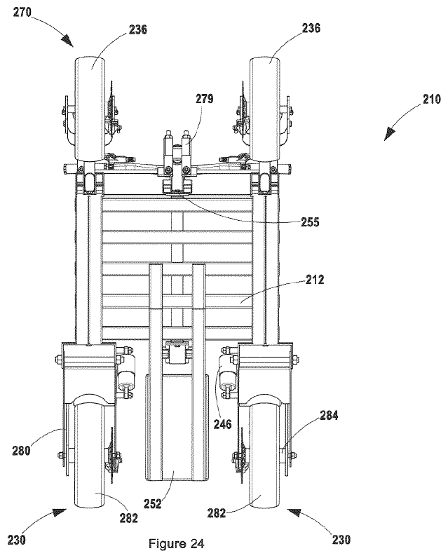

With reference also to FIG. 23, the vehicle 210 includes at least one transverse connector 254, lying transversely and more particularly perpendicularly across the primary wheel assembly pivot axes A-A. Furthermore, the transverse connector 254 is pivotally connected at or near its opposing ends to one of the respective support posts 232 by respective pivot shafts 253 such that the primary wheel assemblies 230 are pivotal relative to the transverse connector 254 about respective co-planar transverse connector axes B-B, being parallel with and spaced from the primary wheel assembly pivot axes A-A.

With the primary wheel assemblies 230 pivotally connected to one another by the transverse connector 254, the primary wheel assemblies 230, and consequentially the secondary wheel assemblies 270 rigidly connected thereto by the support beams 238, are constrained to a synchronous lateral tilting movement relative to the platform 212.

Furthermore, the vehicle 210 includes a post connector 256 pivotally connected at one end by a pivot shaft 255 to the first connecting end 214 of the platform 212 and at a secondary location along its span to the transverse connector 254 by a pivot shaft 257 as best illustrated in FIG. 24 Bottom.

The post connector 256 is centred between the primary support posts 232 of the primary wheel assemblies 230. Connected to the post connector 256 is a further steering mount 274 through which a steering column 276 is rotatably supported on the post connector 256 thereby enabling the steering column 276 to tilt synchronously with the post connector 256.

As such, the post connector 256 is pivotal relative to the platform 212 about a central axis C-C passing longitudinally through the opposing connecting ends 214, 216 of the platform 212, which central axis C-C is parallel and co-planar with the primary wheel assembly pivot axes A-A, and about which both the primary and the secondary wheel assembly 230, 270 are pivotal relative to the platform 212.

The steering column 276 supports a handle bar 278 at or near an upper end thereof and a steering bracket 279 at or near a lower end thereof, to which steering bracket 279 an upper end of the primary steering tubes 235 are pivotally connected by tie rods 281. In this manner, the primary wheels 236 are steerable left-and-right about their respective steering axes D-D via a left-and-right rider applied steering action to the handle bar 278.

With reference specifically to FIG. 19, FIG. 23 and FIG. 21, each of the secondary wheel assemblies 270 further comprises a secondary fork 280 pivotally connected to the secondary support post 272 by pivot 244, in a motorcycle swing arm fashion, with a spring and/or damper 246 connected between the secondary support post 272 and the secondary fork 280 to damp out ride vibrations. Each of the respective secondary wheels 282 is rotatably mounted on the respective secondary fork 280 by a secondary through axle 284 extending across the secondary fork 280.

It will be appreciated that different types of drives may power the vehicle 10. In the illustrated Figures, the drive is electric made up of a pair of electric motors 250 and transmission mounted on each of the secondary wheel assemblies 270, a power source in the form of batteries 252 mounted to the platform 212 and a controller (not shown).

It will be appreciated further that the electric motors 250 and the power source 252 are mounted longitudinally beyond and outside of a longitudinal platform span L, delimited by first and second connecting ends 214, 216 of the platform 212. By mounting the electric motors 250 on the secondary wheel assemblies 270, thereby enabling the electric motors 250 to synchronously tilt with the secondary wheel assemblies 270, transmission alignment between each of the electric motors 250 and the respective secondary wheels 282 becomes simplified.

From the accompanying illustrations, it will be appreciated that the power source 252 is rigidly mounted to the platform 212 and as such, orientates together with the platform 212, much the same as described in respect of the first three-wheeler configuration of the vehicle 10.

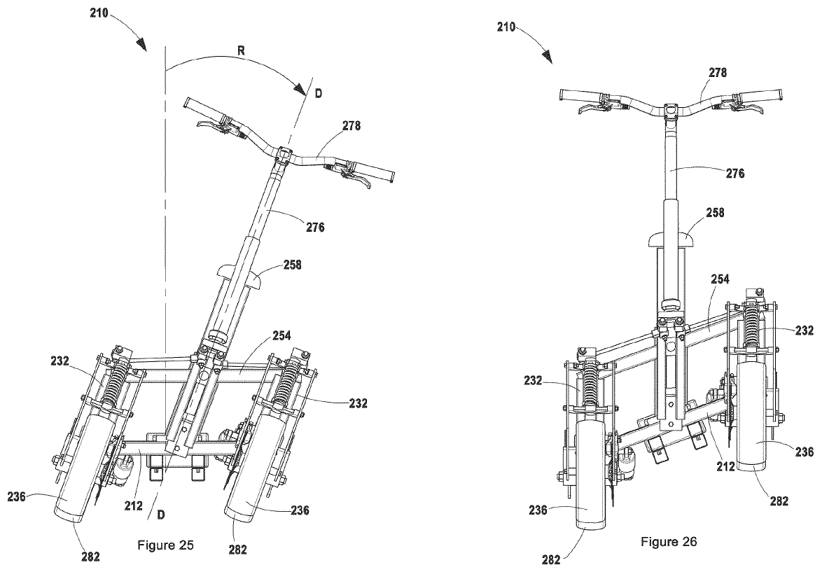

With reference also to FIG. 25, showing the vehicle 210 during a cornering manoeuvre, and FIG. 26, showing the vehicle 210 as if riding along a slope, it will be appreciated that with the transverse connector 254, the platform 212, the primary support posts 232, the secondary support posts 272 and the post connector 256 pivotally connected as described and illustrated, the transverse connector 254 and the platform 212 are constrained to remain parallel to one another throughout the tilting movement range R of the vehicle 210. All the while, the steering column 276, primary wheels 236 and the secondary wheel 282 tilt synchronously relative to the platform 212.

Although not required, the vehicle 210 further includes a seat 258 mounted on a seat post 260, which seat post 260 is pivotally connected at one end to the second connecting end 216 of the platform 212, thereby being pivotal relative thereto about the central axis C-C, and rigidly connected to the post connector 256 by a longitudinal connector 264, such that the seat post is capable of lateral tilting synchronous with the steering column 276, the primary wheels 236 and the secondary wheels 282.

In essence, at least the post connector 256, the longitudinal connector 264 and the seat post 260 together form a central tilt control frame, flanked on either side by the primary and the secondary wheel assemblies 230, 270.

Either in a standing or a seated position on the platform 212, the rider is capable of applying a leveraged leaning force to the central tilt control frame via the handle bar 278 and/or seat 258, which is transmittable to a synchronous tilting movement of the primary and the secondary wheel assemblies 230, 270 via the transverse connector 254.

It will be appreciated that the characteristics, advantages and rider experience of this third configuration of the vehicle 210 is much the same as the characteristics, advantages and rider experience described in respect of the first and the second configuration of the vehicle 10, 110.

Although the invention has been described with reference to a preferred embodiment, it will be appreciated that many modifications or variations of the invention are possible without departing from the spirit or scope of the invention.

For example, support beam itself may be shaft acting both to support the weight of the platform and provide a pivot about which the platform is pivotal. In another example, the longitudinal connector may pass through or beneath the platform. In yet another example, the drive may be in the form of an internal combustion engine, transmission and fuel tank.

Furthermore, the vehicle 10, 110, 210 may be foldable or collapsible for easy transportation or storage, may include a tilt lock to lock the vehicle against tilting and may include a removable lightweight roof and front windscreen to give the rider some protection from the sun, wind and weather.

1. A vehicle including:
a platform having opposing first and second connecting ends, opposing lateral sides and an upper support surface for supporting a rider;
a pair of primary wheel assemblies pivotally connected to the first connecting end of the platform such that the primary wheel assemblies are laterally spaced and pivotal relative to the platform about respective primary wheel assembly pivot axes passing longitudinally through the opposing connecting ends of the platform;
at least one secondary wheel assembly pivotally connected to the second connecting end of the platform such that the at least one secondary wheel assembly is pivotal relative to the platform about a secondary wheel assembly pivot axis passing longitudinally through the opposing ends of the platform, the secondary wheel assembly pivot axis being parallel with the primary wheel assembly pivot axes;
at least one transverse connector pivotally connected to the primary wheel assemblies such that the primary wheel assemblies are pivotal relative to the transverse connector about respective co-planar transverse connector axes, being parallel with and spaced from the primary wheel assembly pivot axes, wherein the transverse connector lies transversely relative to the primary pivot axes and constrains the primary wheel assemblies to a synchronous lateral tilting movement relative to the platform; and
at least one longitudinal connector rigidly connecting the at least one secondary wheel assembly to: (i) at least one of the primary wheel assemblies; or (ii) a post connector pivotally connected to the first connecting end of the platform and to the transverse connector; such that the secondary wheel assembly is constrained by the longitudinal connector to a lateral tilting movement synchronous with the primary wheel assemblies;
characterised in that first and second connecting ends of the platform delimit a longitudinal platform span, longitudinally outside of which the wheel assemblies lie such that at least the upper support surface of the lateral sides of the platform are clear from obstruction to enable lateral step-on entry onto the platform by the rider from either lateral side thereof.

2. A vehicle according to claim 1, wherein each of the primary wheel assemblies comprises at least a primary support post pivotally connected to the platform, a primary fork pivotally supported on the primary support post and a primary through axle mounted across the primary fork on which a primary wheel is rotatably mounted on the primary fork.

3. A vehicle according to claim 2, wherein the at least one secondary wheel assembly comprises at least a secondary support post pivotally connected to the platform, a secondary fork pivotally supported on the secondary support post and a secondary through axle mounted across the secondary fork on which a secondary wheel is rotatably mounted on the secondary fork, such that the vehicle is supportable on a surface by the primary and secondary wheels.

4. A vehicle according to claim 3, wherein the primary and secondary wheel assemblies further comprise one or more springs and/or dampers for damping vibrations to the respective primary and secondary support posts.

5. A vehicle according to claim 4, wherein the primary wheel assemblies further comprise a support beam extending longitudinally from the primary support post such that the primary support post lies at or near a first end of the support beam, the support beam being rigidly connected to or integral with the primary support post to co-operatively form a substantially L-shaped support frame, with the platform pivotally supported along the span of the support beam thereof.

6. A vehicle according to claim 5, wherein the support beam is a pivot shaft sized and shaped to pass through a respective corresponding pivot bore defined through the platform and extending across the connecting ends thereof, such that the respective primary wheel assembly pivot axis passing centrally through the pivot shaft and corresponding pivot bore is located at or near each of the lateral sides of the platform.

7. A vehicle according to claim 6, wherein the support beam comprises a support lug located at or near a second end of the support beam such that the platform is pivotally supported between the primary support post and the support lug on one or more pivot shafts extending between the primary support post, the support lug and the respective connecting ends of the platform, such that the respective primary wheel assembly pivot axis passing centrally through the pivot shaft and corresponding pivot bores, defined in one or the other of the primary support post, support lug or connecting ends of the platform, is located at or near each of the lateral sides of the platform.

8. A vehicle according to claim 7, wherein the platform and the support frame are configured such that the primary wheel assembly pivot axes, relative to the surface on which the vehicle is a supportable by the wheels, lies beneath the upper support surface of the platform.

9. A vehicle according to claim 8, wherein the platform lies over the support beams of the laterally spaced support frames such that at least the upper support surface of the lateral sides of the platform are clear from obstruction to enable lateral step-on entry onto the platform by the rider from either lateral side of thereof.

10. A vehicle according to claim 9 including a drive for driving one or more of the primary or the secondary wheels, wherein the drive comprises one or more of: (i) an electric motor, a power source, a transmission and a controller; or (ii) an internal combustion engine, fuel tank for delivering fuel to the engine and a transmission.

11. A vehicle according to claim 10, wherein the drive is located on the vehicle longitudinally outside of the longitudinal platform span, such that the upper support surface of the platform is substantially clear from obstruction to enable the rider to laterally step over the platform from one lateral side to the other.

12. A vehicle according to any one of the preceding claims, wherein configured as a three-wheeler, the vehicle comprises:
the opposing first and second connecting ends of the platform as respective rear and front connecting ends thereof;
the primary wheel assemblies as rear wheel assemblies thereof, wherein at least one of the primary wheel assemblies has the electric motor mounted thereon thereby enabling the electric motor to tilt synchronously with the primary wheel assemblies, and further wherein the post connector is located centrally between the primary support posts of the primary wheel assemblies, with the at least one transverse connector pivotally connected between the post connector and the primary support posts of the primary wheel assemblies; and
the secondary wheel assembly as a front wheel assembly thereof, wherein the longitudinal connector rigidly connects the post connector to the secondary support post of the secondary wheel assembly, and further wherein the secondary wheel assembly is steerable via a steering column pivotally supported on the secondary support post via a steering mount thereby enabling the steering column to tilt synchronously with the secondary support post, the steering column supporting a handle bar at or near an upper end thereof and the secondary fork, through axle and wheel at or near a lower end thereof, such that the secondary wheel is steerable left-and-right about a steering axis passing through the steering column and substantially diametrically through the secondary wheel.

13. A vehicle according to claim 12, wherein the power source and/or the fuel tank are be mounted rigidly to the platform, longitudinally beyond the longitudinal platform span, thereby to prevent any relative movement between the power source and/or the fuel tank and the platform.

14. A vehicle according to claim 12, wherein the power source and/or the fuel tank are mounted to the post connector enabling the power source and/or the fuel tank to tilt with the post connector relative to the platform.

15. A vehicle according to claim 13 or claim 14, wherein a seat is mounted on the post connector by a seat post.

16. A vehicle according to claim 15, wherein the seat and/or seat post are removable to convert the vehicle between respective stand-on or sit-stand vehicle configurations.

17. A vehicle according to any one of claims 1 to 11, wherein configured as a three-wheeler, the vehicle comprises:
the opposing first and second connecting ends of the platform as respective front and rear connecting ends thereof;
the primary wheel assemblies as steerable front wheel assemblies thereof;
wherein the post connector is located centrally between the primary support posts of the primary wheel assemblies with the at least one transverse connector pivotally connected between the post connector and the primary support posts of the primary wheel assemblies, the post connector pivotally supporting a steering column via a steering mount thereon with the steering column supporting a handle bar at or near an upper end thereof and a steering bracket at or near a lower end thereof thereby enabling the steering column to tilt synchronously with the post connector; and
further wherein primary steering tubes are pivotally supported on each of the primary support posts thereby enabling the primary steering tubes to tilt synchronously with the primary support posts, with each of the primary steering tubes supporting the primary fork, through axle and wheel at or near a lower end thereof and being connected by tie rods to the steering bracket at or near an upper end thereof, such that the primary wheels are steerable left-and-right about respective steering axes passing through the respective steering tube and substantially diametrically through the respective primary wheel; and
the secondary wheel assembly as a rear wheel assembly thereof, wherein the longitudinal connector rigidly connects the post connector to the secondary support post of the secondary wheel assembly, and further wherein the electric motor is mounted on the secondary wheel assembly thereby enabling the electric motor to tilt synchronously with the secondary wheel assembly.

18. A vehicle according to claim 17, wherein the power source and/or the fuel tank are mounted rigidly to the platform, longitudinally beyond the longitudinal platform span, thereby to prevent any relative movement between power source and/or the fuel tank and the platform.

19. A vehicle according to claim 17, wherein the power source and/or the fuel tank are mounted to the secondary support post enabling the power source and/or the fuel tank to tilt with the secondary support post relative to the platform.

20. A vehicle according to claim 18 or claim 19, wherein a seat is mounted on the secondary support post by a seat post.

21. A vehicle according to claim 20, wherein the seat and/or seat post are removable to convert the vehicle between respective stand-on or sit-stand vehicle configurations.

22. A vehicle according to any one of claims 1 to 11, wherein configured as a four-wheeler, the vehicle comprises:
the opposing first and second connecting ends of the platform as respective front and rear connecting ends thereof;
the primary wheel assemblies as steerable front wheel assemblies thereof;
wherein the post connector is located centrally between the primary support posts of the primary wheel assemblies with the at least one transverse connector pivotally connected between the post connector and the primary support posts of the primary wheel assemblies, the post connector pivotally supporting a steering column via a steering mount thereon with the steering column supporting a handle bar at or near an upper end thereof and a steering bracket at or near a lower end thereof thereby enabling the steering column to tilt synchronously with the post connector; and
further wherein primary steering tubes are pivotally supported on each of the primary support posts thereby enabling the primary steering tubes to tilt synchronously with the primary support posts, with each of the primary steering tubes supporting the primary fork, through axle and wheel at or near a lower end thereof and being connected by tie rods to the steering bracket at or near an upper end thereof, such that the primary wheels are steerable by the steering column left-and-right about respective steering axes passing through the respective steering tube and substantially diametrically through the respective primary wheel; and
a pair of the secondary wheel assemblies as rear wheel assemblies thereof,
wherein the primary wheel assembly pivot axis of each of the primary wheel assemblies is co-axial with one of the secondary wheel assembly pivot axis of the respective secondary wheel assembly, and
further wherein the longitudinal connector is the support beam rigidly connecting between the respective primary and secondary support posts, with the secondary support post replacing the support lug and with at least one of the secondary wheel assemblies having the electric motor mounted thereon thereby enabling the electric motor to tilt synchronously with the primary and the secondary wheel assemblies.

23. A vehicle according to claim 22, wherein the power source and/or the fuel tank are mounted rigidly to the platform, longitudinally beyond the longitudinal platform span, thereby to prevent any relative movement between power source and/or the fuel tank and the platform.

24. A vehicle according to claim 23, the vehicle includes a seat post having a seat mounted thereon, the seat post being pivotally mounted centrally to the second connecting end of the platform and rigidly connected to the post connector by a secondary longitudinal connector thereby enabling the seat post to tilt synchronously with the post connector.

25. A vehicle according to claim 24, wherein the power source and/or the fuel tank are mounted to a seat post having a seat mounted thereon, the seat post being pivotally mounted centrally to the second connecting end of the platform and rigidly connected to the post connector by a secondary longitudinal connector thereby enabling the seat post to tilt synchronously with the post connector.

26. A vehicle according to claim 25, wherein the seat and/or seat post are removable to convert the vehicle between respective stand-on or sit-stand vehicle configurations.

27. A vehicle according to any one of claims 1, 12 or 17, wherein the one or more transverse connectors, the platform, the primary support posts, the secondary support post and the post connector are pivotally connected such that throughout the tilting movement range of the vehicle:
the transverse connectors and the platform remain parallel to one another; and
the primary support posts, the secondary support post and the post connector, and consequentially the primary and the secondary wheels, remain parallel to one another.

28. A vehicle according to claim 27, wherein the secondary wheel assembly pivot axis/axes is co-planar with the respective primary wheel assembly pivot axes, and further wherein the handle bar includes a throttle control, for controlling the output of the drive and consequentially the speed of the vehicle, and at least one brake control, for controlling brakes co-operative with the primary and secondary wheels.

29. A vehicle according to claim 28, wherein the ratio of:
the handle bar height to the primary wheel assembly pivot axes, measured from the surface on which the vehicle is supportable, is between about 4:1 and 6:1; and
the seat height to the primary wheel assembly pivot axes, measured from the surface on which the vehicle is supportable, is between about 3:1 and 4:1.

30. A vehicle according to claim 29, wherein the longitudinal connector or the secondary longitudinal connector extends across the longitudinal platform span of the platform either beneath the platform, through the platform or over the platform no higher than 25 millimetres above the upper support surface thereof, such that other than the longitudinal connector passing over the platform, the upper support surface of the platform is unobstructed to enable the rider to laterally step over and through the platform from one lateral side to the other.
